(19) United States
(12) Patent Application Publication
(10) Pub. No.: US 2026/0220785 A1
(43) Pub. Date: Jul. 30, 2026

(54) Method, Apparatus, Device and Product for Instance Segmentation

(71) Applicant: Robert Bosch GmbH, Stuttgart (DE)

(72) Inventors: Yunxiang LU, Shanghai (CN); Xuchong QIU, Shanghai (CN)

(21) Appl. No.: 19/430,531

(22) Filed: Dec. 23, 2025

(30) Foreign Application Priority Data
Dec. 26, 2024 (CN) 2024 1194 2118.6

(51) Int. Cl. G06T 7/12; G06V 10/25; G06V 10/46; G06V 10/80

(52) U.S. Cl. CPC G06T 7/12; G06V 10/25; G06V 10/46; G06V 10/806; G06T 2207/20081

(57) ABSTRACT

A method for image instance segmentation includes determining, based on an input image, region of interest features of a target object in the input image and a target region image of the target object, and extracting shape features of the target object based on the target region image. The method further includes determining fused features of the target object based on the region of interest features and the shape features; and based on the fused features, performing instance segmentation of the input image to generate a mask instance of the target object in the input image.

This application claims priority under 35 U.S.C. § 119 to patent application no. CN 2024 1194 2118.6, filed on Dec. 26, 2024 in China, the disclosure of which is incorporated herein by reference in its entirety.

The present disclosure relates to the field of computer vision technology, and more particularly, to methods, devices, apparatuses, and products for image instance segmentation.

### BACKGROUND

When using computer vision technology for scene understanding, there are many situations where objects (including things and people) are occluded. In scenarios where an object is partially occluded, the complete shape of the occluded object is perceived based on prior knowledge, and the boundary information of the occluded region is described to perform instance segmentation on the image.

### SUMMARY

Examples of the present disclosure propose a method, apparatus, device, and product for image instance segmentation.

In a first aspect of the present disclosure, a method for image instance segmentation is provided. The method comprises determining, based on the input image, the region of interest features of a target object in an input image and the target region image of the target object. The method further comprises extracting the shape features of the target object based on the target region image. The method further comprises determining the fused features of the target object based on the region of interest features and shape features. Additionally, the method further comprises, based on the fused features, instance segmentation of the input image to generate a mask instance of the target object in the input image.

In a second aspect of the present disclosure, a method for training an image segmentation model is provided, the image segmentation model comprising a main model and an auxiliary model. The method comprises acquiring training samples comprising a plurality of sample images and a plurality of mask sample instances corresponding to sample objects in the sample images. The method further comprises extracting, by the auxiliary model, shape features of the sample objects in the sample images. The method further comprises instance segmentation of the sample images by the main model based on fused features to generate mask prediction instances of the sample objects in the sample images, the fused features being determined based on the region of interest features and shape features of the sample objects in the sample image. The method further comprises generating, by the auxiliary model, mask projection instances of the sample objects based on the shape features of the sample objects in the sample images and the camera pose. Additionally, the method further comprises jointly training the main model and the auxiliary model based on the mask prediction instances and the mask projection instances, using the mask sample instances corresponding to the sample images as the supervision signals.

In a third aspect of the present disclosure, an apparatus for image instance segmentation is provided. The apparatus comprises a generation module configured to generate region of interest features of a target object in an input image and a target region image of the target object based on the input image. The apparatus further comprises an extraction module configured to extract shape features of a target object based on the target region image. The apparatus further comprises a fusion module configured to determine the fused features of the target object based on the region of interest features and the shape features. Additionally, the apparatus further comprises a segmentation module configured to perform, based on the fused features, instance segmentation of the input image to generate a mask instance of the target object in the input image.

In a fourth aspect of the present disclosure, an electronic device is provided. The electronic device comprises at least one processor. The electronic device further comprises a memory, which is coupled to the at least one processor and has instructions stored thereon that, when executed by the at least one processor, cause the electronic device to execute the method provided according to the first aspect.

In a fifth aspect of the present disclosure, a computer program product is provided, comprising a computer program, which is executed by a processor to implement the method provided according to the first aspect.

In a sixth aspect of the present disclosure, a computer-readable storage medium is provided, having computer-executable instructions stored thereon, which, when executed by a processor, implement the method according to the first aspect of the present disclosure.

It will be understood that the content described in the Summary is not intended to limit key or important features of the examples of the present disclosure, nor is it intended to limit the scope of the present disclosure. Other features of the present disclosure will become readily understood by the following description.

### BRIEF DESCRIPTION OF THE DRAWINGS

Above and other features, advantages and aspects of various examples of the present disclosure will become more apparent in combination with the accompanying drawings and with reference to the following detailed description. In the accompanying drawings, like or similar accompanying drawings designate like or similar elements, wherein:

FIG. 1 shows a schematic diagram of an example environment in which some examples of the present disclosure may be implemented;

FIG. 2A shows a flowchart of a method for image instance segmentation according to some examples of the present disclosure;

FIG. 2B shows a flowchart of a method for training an image instance segmentation model according to some examples of the present disclosure;

FIG. 3 shows a schematic diagram of the overall training architecture of an image segmentation model according to some examples of the present disclosure;

FIG. 4 shows a schematic diagram of the training process of an image segmentation model according to some examples of the present disclosure;

FIG. 5 shows a schematic diagram of an inference process for image instance segmentation according to some examples of the present disclosure;

FIG. 6 shows a block diagram of an apparatus for image instance segmentation according to some examples of the present disclosure;

FIG. 7 shows a block diagram of a device which can implement some examples of the present disclosure.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to.” The term “based on” should be understood as “at least partially based on.” The term “one example” or “this example” should be understood as “at least one example.” The terms “first,” “second,” etc. may refer to different or the same object. Other explicit and implicit definitions may be included below.

Traditional instance segmentation tasks focus on the visible parts of an object. Unlike traditional instance segmentation tasks, amodal instance segmentation tasks require inferring the shape of an occluded object to obtain a complete object outline. The object may be an object, human, animal, etc. in the image. This ability to infer clues about invisible objects from the form of visible objects is called amodal prediction. Related deep learning methods can accomplish amodal instance segmentation tasks. While the method can segment and predict the entire object region, including both the visible and invisible parts of the object, there are issues with low quality in the occluded regions of the object.

To this end, examples of the present disclosure provide a solution for image instance segmentation that can achieve amodal prediction. In examples of the present disclosure, the solution may determine the ROI features (also referred to herein as region of interest features) and shape features of an object based on an input image. The solution may then determine the fused features of the object based on the ROI features and shape features of the object and perform image instance segmentation based on the fused features of the object to generate a mask instance of the object.

In this way, the solution combines the shape information of the object with its ROI features and can more accurately identify the boundary contour of the object region based on the shape characteristics of the object. In this way, the solution is able to focus on the entire region of the object, especially the region occluded by other objects, when performing image instance segmentation, thereby addressing the issue of insufficient prediction accuracy in existing instance segmentation tasks.

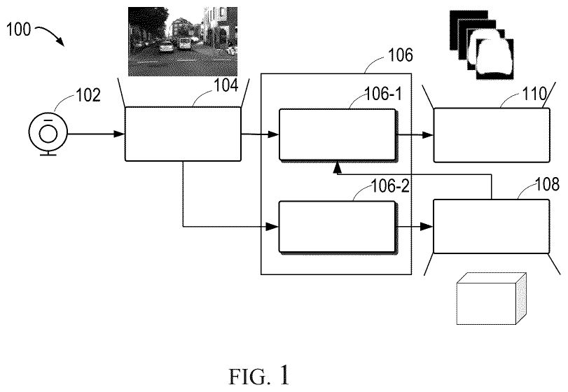

FIG. 1 shows a schematic diagram of an example environment 100 in which some examples of the present disclosure may be implemented. As shown in FIG. 1, the environment 100 comprises a camera 102 for capturing images in the environment. In some examples, the camera 102 is mounted on the vehicle to capture images of the environment surrounding the vehicle, which may be images of the front of the vehicle, the rear of the vehicle, or the side of the vehicle. In some examples, the camera 102 is mounted on a door to capture images of the environment outside the door. Additionally, the camera 102 may further be provided in other application scenarios for capturing environmental images in that application scenario for image instance segmentation tasks.

As shown in FIG. 1, the environment 100 further comprises a controller 106 for receiving an environmental image 104 captured by the camera 102 and processing the environmental image 104. The controller 106 is in communication with the camera 102 to communicate via wired or wireless transmission. An image segmentation model is deployed within the controller 106 and comprises a main model 106-1 and an auxiliary model 106-2. The main model 106-1 in the controller 106 may determine the ROI features of an object based on the environmental image 104. For example, if a bicycle in the environment image 104 is object A, then the main model 106-1 can determine the ROI features of the bicycle, i.e., the ROI features of object A. For another example, if a car in the environment image 104 is object B, then the main model 106-1 can determine the ROI features of the car, i.e., the ROI features of object B. The auxiliary model 106-2 in the controller 106 may determine the shape features 108 of an object based on the environmental image 104. For example, if a bicycle in the environment image 104 is object A, then the auxiliary model 106-2 can determine the shape features of the bicycle, i.e., the shape features of object A. For another example, if a car in the environment image 104 is object B, then the auxiliary model 106-2 can determine the shape features of the car, i.e., the shape features of object B. The main model 106-1 of the controller 106 performs feature fusion based on the ROI features and shape features 108 of the object and performs image instance segmentation on the environment image 104 based on the fused features to generate a mask instance 110 of the object. For example, the main model 106-1 generates a mask instance of object A based on the ROI features and shape features of object A. The main model 106-1 further generates a mask instance of object B based on the ROI features and shape features of object B.

In this way, the main model takes into account the shape characteristics of the objects determined by the auxiliary model in the instance segmentation of the input image. It can utilize the fused features formed by ROI features and shape features to more accurately predict the mask instances of objects. In particular it can identify the boundary contours of the occluded regions of objects with higher quality. In this way, by using the model to determine the shape characteristics (3D shape features) of objects in the input image, the occluded regions between objects can be predicted, thus improving the accuracy of object mask instance prediction. Furthermore, based on object mask instances, target detection images containing all objects can be generated, improving the accuracy of target detection in any detection scenario.

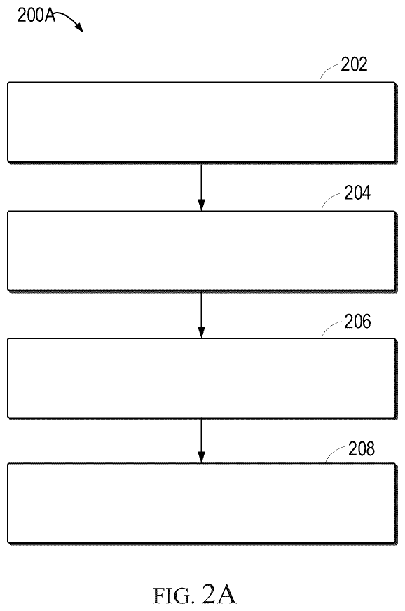

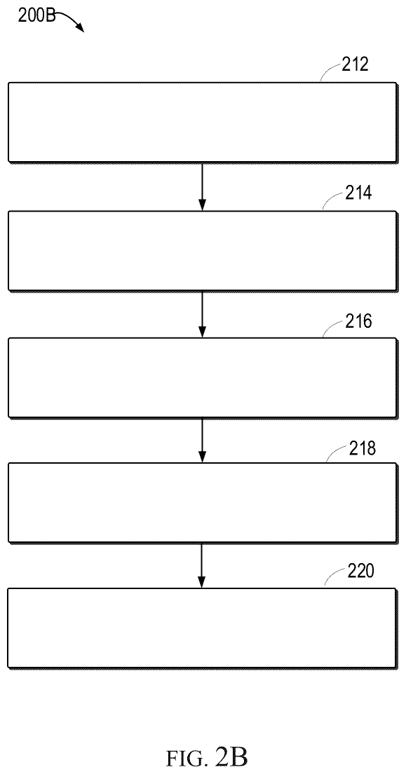

FIG. 2A shows a flowchart of a method 200A for image instance segmentation according to some examples of the present disclosure. The method 200A may be performed, e.g., by a controller 106 in the environment 100 shown in FIG. 1. As shown in FIG. 2A, in block 202, the method 200A may determine the region of interest features of a target object in an input image and the target region image of the target object based on the input image. For example, in the environment 100 as shown in FIG. 1, the environment image 104 is the input image, and the controller 106 can determine the features of interest and target region image of the environment image 104 acquired by the camera 102.

In block 202, determining the region of interest features of a target object in an input image based on the input image comprises extracting image features from the input image and determining the region of interest features based on the image features. In some examples, a feature extraction network, such as a convolutional neural network (CNN), may be utilized to extract image features from the input image. In some examples, a bounding box containing the target region is generated using a region proposal network (RPN) based on image features. A region of interest (ROI) network is then utilized to extract the region of interest (ROI) features from the bounding box. Optionally, the ROI network may adopt an ROI pooling or ROI align network.

In block 202, determining the target region image of a target object in an input image based on the input image comprises extracting image features from the input image, determining the bounding box of the target object based on the image features, extracting region of interest features from the bounding box, and generating the target region image of the target object based on the region of interest features. In some examples, image features may be extracted from an input image utilizing a feature extraction network, such as a CNN. In some examples, a bounding box is generated with an RPN based on image features, the bounding box containing the target region. An ROI network is then utilized to extract region of interest features from the bounding box. In some examples, the feature map is cropped based on the region of interest features to obtain the target region image of the target object. For example, when there are a plurality of target objects in an input image, the feature map is cropped based on the bounding box of each target object to obtain the target region image of each target object. That is, a target object has a target region image.

In some examples, when determining the region of interest features of a target object in an input image and the target region image of the target object based on the input image, the feature extraction network and RPN network may be shared.

In block 204, the method 200A may extract the shape features of the target object based on the target region image. In some examples, a pre-trained encoder is utilized to extract the shape features of the target object from the target region image. The encoder learns the 3D shape features of the object during the training phase by utilizing the 3D perspective of the object in the image. During the inference phase, the encoder may extract the shape features of the object.

In block 206, the method 200A may determine the fused features of the target object based on the region of interest features and shape features. In some examples, the fused features are determined by connecting the region of interest features and shape features along a depth channel. For example, by connecting the ROI feature tensor and the shape feature tensor along a depth channel, a fused feature containing the 3D shape information of the target object can be obtained.

In block 208, the method 200A may perform, based on the fused features, instance segmentation of the input image to generate a mask instance of the target object in the input image. In some examples, a mask instance of the target object containing the visible parts, invisible parts, and occluded parts of the input image is generated based on the fused features. Visible parts typically refer to objects or regions in an image that are not occluded or covered. Invisible parts refer to parts of objects that are theoretically present but do not appear in the current view or image. These parts may not appear in the image due to factors such as the camera's angle, image cropping boundaries, or the object's position itself. Occluded parts refer to parts that are blocked by other objects, meaning that these parts cannot be directly seen because there are other objects in front of them. Optionally, predicted mask instances may be output using a mask prediction network based on fused features. For example, the mask prediction network may output mask instances of the visible, invisible, and occluded parts using AIS Former.

In this way, as the shape features reflect the shape information of the object, combining shape features with ROI features to perform image instance segmentation can help the image segmentation model focus on the overall region of the object, including the visible, invisible, and occluded parts. In this way, the boundary contours of the object, particularly the boundary contours of the parts of the object that are occluded by other objects, can be accurately predicted.

FIG. 2B shows a flowchart of a method 200B for training an image instance segmentation model according to some examples of the present disclosure. The image segmentation model comprises a main model and an auxiliary model. The main model is capable of generating mask instances of objects based on their fused features. The auxiliary model is used to assist the main model in training so as to help the shape encoder in the main model learn the 3D shape features of the object. The main model can then obtain fused features containing the 3D shape information of the object. The method 200B comprises being performed, e.g., by a controller 106 in the environment 100 shown in FIG. 1. As shown in FIG. 2B, in block 212, the method 200B comprises acquiring training samples comprising a plurality of sample images and a plurality of mask sample instances corresponding to sample objects in the sample images.

In block 214, the method 200B may extract the shape features of sample objects in a sample image based on the auxiliary model. In some examples, the auxiliary model comprises a shape encoder for extracting the shape features of the sample objects.

In block 216, the method 200B may perform instance segmentation on the sample image by the main model based on fused features to generate mask prediction instances of sample objects in the sample image. The mask prediction instances of sample objects are determined based on fused feature segmentation after fusing the region of interest features and shape features of the sample objects. In some implementations, the main model comprises a backbone network, a shape encoder, a fusion module, and a mask prediction network. The fusion module fuses the shape features of a sample object extracted by the shape encoder with the ROI features output by the backbone network to obtain fused features. The mask prediction network generates mask prediction instances based on fused features.

In block 218, the method 200B may generate, by the auxiliary model, mask projection instances of the sample objects based on the shape features of the sample objects in the sample images and the camera pose. In some examples, the auxiliary model comprises a shape decoder and a view estimator. The view estimator obtains the angle of the sample object captured by the virtual camera and the shape decoder determines the shape feature body based on the shape features output by the shape encoder. The auxiliary model projects the shape feature body based on the camera pose, converting the 3D shape into a 2D shape and generating a mask projection instance.

In block 220, the method 200B may jointly train the main model and the auxiliary model based on the mask prediction instances and the mask projection instances, using the mask sample instances corresponding to the sample images as the supervision signals. In some examples, the loss between the mask prediction instance and the mask sample instance as well as the loss between the mask projection instance and the mask sample instance are calculated. Based on the loss, the parameters of the shape encoder, shape decoder, and fusion module in the image segmentation model are adjusted until training converges. There is no need to adjust the view estimator parameters during this process. Upon completion of the training, the auxiliary model (comprising the view estimator and shape decoder) is removed and the main model is used for inference.

In this way, the auxiliary model is utilized to assist the main model in training to enable the shape encoder of the main model to learn the shape features of the object. Thereafter, the main model is capable of accurately segmenting image instances, particularly instances of occluded parts, based on fused features that include 3D shape information.

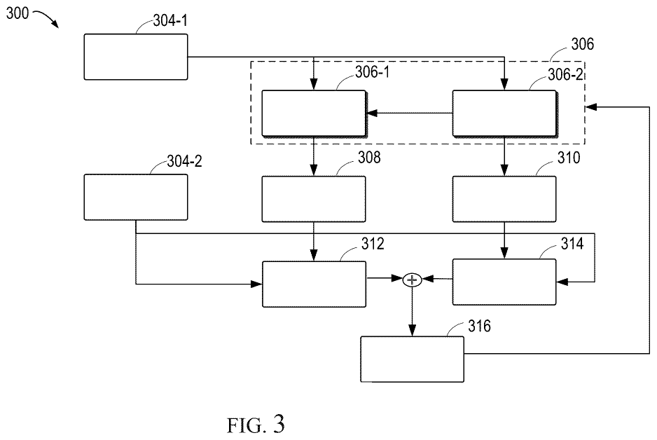

FIG. 3 shows a schematic diagram of the overall training architecture 300 of an image segmentation model according to some examples of the present disclosure. The method 200A for image instance segmentation shown in FIG. 2A is implemented by an image segmentation model. As shown in FIG. 3, the overall training structure 300 comprises an image segmentation model 306. The image segmentation model 306 comprises a main model 306-1 and an auxiliary model 306-2. The main model 306-1 comprises a fusion module for determining the fused features of a target object. The auxiliary model 306-2 comprises a shape encoder for extracting the shape features of a target object. As shown in FIG. 3, the auxiliary model 306-2 extracts the shape features of a sample object based on a sample image 304-1 in the training samples and sends them to the fusion module in the main model 306-1. The main model 306-1 extracts the ROI features of the sample object based on the sample image 304-1. The fusion module of the main model 306-1 connects the ROI features and shape features of the sample object to obtain the fused features. The main model 306-1 obtains a mask prediction instance 308 of the sample object based on the fused features. The auxiliary model 306-2 obtains a mask projection instance 310 of the sample object based on the shape features. The main model 306-1 and the auxiliary model 306-2 are then jointly trained with mask sample instance 304-2 in the training sample set as the supervision signal.

In some examples, a first loss 312 is calculated based on the mask prediction instance 308 and the mask sample instance 304-2 of the sample object and a second loss 314 is calculated based on the mask projection instance 310 and the mask sample instance 304-2 of the sample object. The first loss 312 includes the losses of all target objects. The second loss 314 includes the losses of all target objects. The first loss 312 and the second loss 314 are superimposed to obtain the total loss 316 of the image segmentation model 306. The total loss 316 may be a large value, and then the total loss 316 can be backpropagated to the image segmentation model 306 to guide the optimization of the parameters of the main model 306-1 and the parameters of the shape encoder in the auxiliary model 306-2.

Through the joint training of the two branches, the shape encoder of the auxiliary model can learn the 3D shape characteristics of the object, and the learned 3D features can be well fused with the ROI features. This allows the mask prediction instances of the sample objects output by the main model to be obtained with consideration of the 3D shape information of the object, thereby improving the accuracy of the main model in instance segmentation, especially in predicting mask instances of objects with occlusion relationships with high quality.

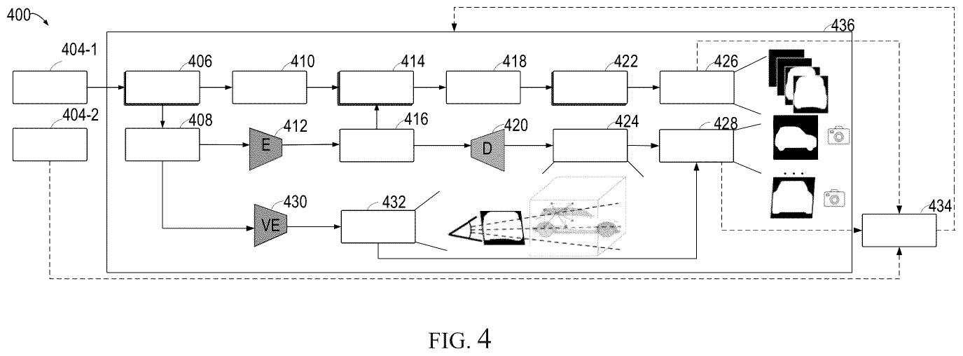

FIG. 4 shows a schematic diagram of the training process 400 of an image segmentation model according to some examples of the present disclosure. As shown in FIG. 4, the image segmentation model 436 is trained based on training samples. The training samples comprises a plurality of sample images 404-1 and a plurality of mask sample instances 404-2 corresponding to sample objects in sample images 404-1. The image segmentation model 436 comprises a main model and an auxiliary model. The main model comprises a backbone network 406, a fusion module 414, and a mask prediction network 422. The auxiliary model comprises a shape encoder 412, a shape decoder 420, and a view estimator 430. In the training process 400, a mask prediction instance 426 of a sample object in the sample image 404-1 is generated by the main model based on the sample image 404-1. Based on the shape features 416 of the sample object in the sample image 404-1 and the camera pose 432, a mask projection instance 428 of the sample object is generated by the auxiliary model. The main model and the auxiliary model are then jointly trained with mask sample instances 404-2 corresponding to the sample images 404-1 as the supervision signals.

As shown in FIG. 4, the process of the main model generating the mask prediction instance 426 of a sample object in the sample image 404-1 needs to be implemented sequentially through the backbone network 406, the fusion module 414, and the mask prediction network 422. In some examples, the backbone network 406 in the main model determines the sample region image 408 of a sample object in a sample image based on the sample image 404-1, and then the shape encoder 412 in the auxiliary model extracts the shape features 416 of the sample object based on the sample region image 408. The backbone network 406 also determines the region of interest features 410 of the sample object in the sample image based on the sample image 404-1. The fusion module 414 in the main model determines the fused features 418 of the sample object based on the region of interest features 410 and shape features 416 of the sample object. The mask prediction network 422 in the main model generates a mask prediction instance 426 of the sample object in the sample image 404-1 based on the fused features 418 of the sample object. The mask prediction instance contains a plurality of mask prediction instances for the target object. Each mask prediction instance masks the target object with binary 0 and non-target objects with binary 1.

As shown in FIG. 4, the process by which the auxiliary model generates a mask projection instance 428 of a sample object in the sample image 404-1 needs to be implemented by the shape encoder 412, the shape decoder 420, and the view estimator 430. In some examples, the backbone network 406 in the main model determines the sample region image 408 of the sample object in the sample image 404-1 based on the sample image 404-1. For example, when there are a plurality of sample objects in a sample image, a plurality of sample region images 408 can be obtained, with each sample region image 408 containing one sample object. The sample region image 408 can be obtained by using the feature extraction network, RPN network, and ROI network in the backbone network to obtain the region of interest features and then cropping the image. Next, the sample region image 408 is input into the shape encoder 412 and the view estimator 430. The shape encoder 412 extracts the shape features 416 of the sample object and sends them to the shape decoder 420. The shape decoder 410 extracts the shape feature body 424 of the sample object based on the shape features 416 of the sample object. Optionally, the shape features 416 can be projected onto a shape feature body 424 having the same width, height, and channel size using a light projection method. The shape feature body 424 represents the reconstruction of the entire object without any occlusion, where each element in the shape feature body 424 represents the probability of a voxel mesh occupying a volume. The shape feature body may be a cube or a cuboid. Based on the sample region image 408, the view estimator 430 extracts the camera pose 432 of the sample object captured by the virtual camera. In some examples, the camera pose comprises the angle and distance at which the virtual camera captures the object. The angle may comprise an azimuth angle and a pitch angle. In still other examples, the virtual camera has a rotation matrix relative to the visual coordinate system in which the object is located, and the rotation angle in the rotation matrix is used to characterize the camera pose. Finally, the auxiliary model generates a mask projection instance 428 of the sample object based on the camera pose 432 and the shape feature body 424. In some examples, a differential rendering module can be used to generate a mask projection instance 428 of the sample object in the sample image through differential rendering based on the camera pose 432 of the sample object captured by the virtual camera in the sample image and the shape feature body 424 of the sample object. In still other examples, the camera pose 432 of the sample object captured by the virtual camera and the shape feature body 424 of the sample object are used to perform vector dot product calculation using the dot product configuration between networks to obtain the mask projection instance 428 of the sample object. That is, based on the camera pose 432, the shape feature body 424 is projected, the 3D shape is converted into a 2D shape, and ultimately a 2D mask projection instance is obtained.

In the training process 400, the image segmentation model 436 is trained with the mask sample instance 404-2 corresponding to the sample image as the supervision signal. The mask sample instance 404-2 is a mask instance with occluding objects marked. As shown by the dashed line in the figure, the mask prediction instance 426 of the sample object output by the main model, the mask projection instance 428 of the sample object output by the auxiliary model, and the mask sample instance 404-2 are all input into the generator loss 434, and the generator loss 434 is used to calculate the total loss value. The total loss value is equal to the sum of the first loss value and the second loss value. The first loss value is calculated using the first loss function based on the mask sample instance 404-2 and the mask prediction instance 426. The second loss value is calculated using the second loss function based on the mask sample instance 404-2 and the mask projection instance 428. Next, the parameters of the fusion module in the main model and the shape encoder and shape decoder in the auxiliary model are adjusted using the total loss value. The first loss function and the second loss function may adopt a cross-entropy loss function.

In the above manner, based on the shape feature body and the camera pose, a set of camera rays passing through the shape feature body is formed, and points are sampled along the rays. The occupancy status of each point can be obtained by trilinear interpolation of the voxels in the volume. Differential rendering may then be used to accumulate the points of light rays onto the image plane to obtain a mask projection instance. Using mask sample instances as 2D supervision, the shape encoder is then trained and optimized so that it can learn the shape features that represent the 3D shape information of the object during the training phase. Finally, the shape encoder fuses the output shape features with the ROI features and inputs the fused features into the mask head in the mask prediction model. Each mask head can obtain a mask instance. In this way, the trained image segmentation model is capable of predicting mask instances of target objects with higher quality.

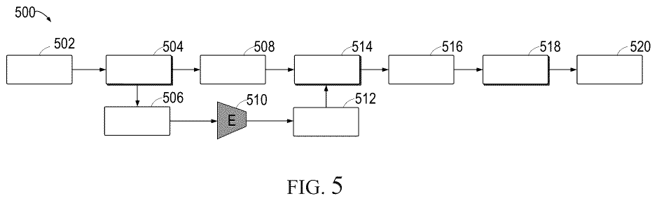

FIG. 5 shows a schematic diagram of an inference process 500 for image instance segmentation according to some examples of the present disclosure. Upon completion of training based on the training process 400 shown in FIG. 4, the shape decoder 420 and the view estimator 430 in the auxiliary model are removed, and the shape encoders in the main model and auxiliary model are put into the inference process for image instance segmentation.

As shown in FIG. 5, the input image 502 is input into the backbone network 504 to obtain the ROI features 508 and the target region image 506. The target region image 506 is input into the shape encoder 510 to output the shape features of the target object 512. The fusion module 514 fuses the ROI features 508 and the shape features 512 to obtain the fused features 516. The mask prediction network 518 predicts a mask instance 520 of the target object based on the fused features 516.

Further, when applied to object detection, the image segmentation model may also generate a target detection image based on the mask instance 520 of the predicted target object. The target detection image displays the visible, invisible, and occluded parts of the target object in the input image.

In this way, the inference phase does not require the shape decoder and the view estimator of the training phase to perform the shape reconstruction process, but rather utilizes the shape encoder to obtain the shape information of the target object in the input image. This not only simplifies the model structure, but also eliminates the process of three-dimensional object reconstruction and improves inference and prediction efficiency. Moreover, the fusion module of the main model fuses the shape features with the ROI features, enabling the main model to predict amodal mask instances more accurately based on the complete information of the object shape.

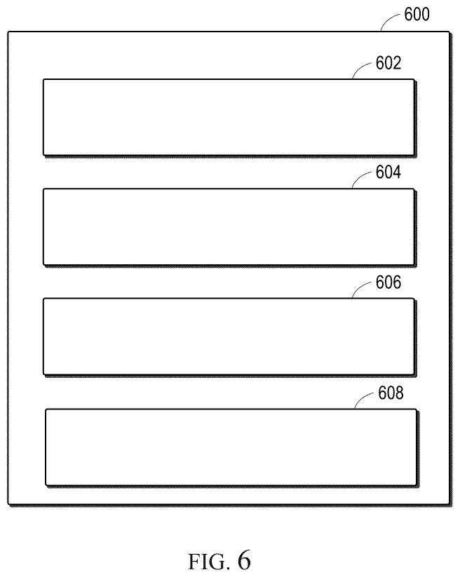

FIG. 6 shows a block diagram of an apparatus 600 for image instance segmentation according to some examples of the present disclosure. As shown in FIG. 6, the apparatus 600 comprises a generation module 602 configured to generate region of interest features of a target object in an input image and a target region image of the target object based on the input image. The apparatus 600 further comprises an extraction module 604 configured to extract shape features of a target object based on the target region image. The apparatus further comprises a fusion module 606 configured to determine the fused features of the target object based on the region of interest features and the shape features. Additionally, the apparatus 600 further comprises a segmentation module 608 configured to perform, based on the fused features, instance segmentation of the input image to generate a mask instance of the target object in the input image.

In some examples, the generation module 602 comprises a backbone network. This backbone network comprises a feature extraction network, an RPN network, and an ROI network. The input image is processed through a feature extraction network to obtain the image features. The image features pass through the RPN network and generate a bounding box that includes the target region. An ROI network is then utilized to extract region of interest features from the bounding box. Further, cropping is performed based on the region of interest features to obtain the target region image of the target object.

In some examples, the extraction module 604 comprises a shape encoder configured to extract the shape features of the target object based on the target region image of the target object.

In some examples, the fusion module 606 is used to connect the region of interest features and the shape features of the target object along the depth channel to form fused features.

In some examples, the segmentation module 608 comprises a mask prediction network configured to predict mask instances of the target object based on the fused features.

In some examples, the apparatus 600 further comprises a training module configured to train the generation module 602, the extraction module 604, the fusion module 606, and the segmentation module 608.

In some examples, the training module comprises a shape decoder, a view estimator, and a generator loss. During the training phase, an auxiliary model for the image segmentation model is constructed using the shape encoder, the shape decoder, and the view estimator, and is jointly trained with the main model consisting of the generation module 602, the fusion module 606, and the segmentation module 608. The auxiliary model learns the 3D shape information of the object. The main model may accurately predict mask instances of the object based on the fused features fused from the object shape information.

The training process uses mask sample instances labeled with occlusions as 2D supervision to train the main model and auxiliary model, with reference to the training process 400 shown in FIG. 4. The parameters of the main model, shape encoder, and shape decoder are adjusted during training. Upon completion of training, inference is performed based on the generation module 602, the extraction module 604, the fusion module 606, and the segmentation module 608.

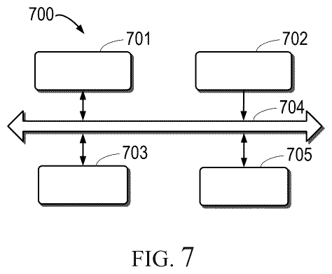

FIG. 7 illustrates a schematic block diagram of an exemplary device 700 that may be used to implement the examples of the present disclosure. The device 700 may correspond to the controller in the above method examples. As shown in FIG. 7, the appliance 700 comprises a processor 701, which can perform various appropriate actions and processes according to computer program instructions stored in a read only memory (ROM) 702 and loaded into a random access memory (RAM) 703. Various programs and data required for the operation of the device 700 may also be stored in the RAM 703. The processor 701, the ROM 702, and the RAM 703 are interconnected through a bus 704. An input/output (I/O) interface 705 is also connected to the bus 704.

The various processes and processing described above, such as the method 200A, the method 200B, and the training process 400, may be executed by the processor 701. For example, in some examples, the method 200A, the method 200B, and the training process 400 can be implemented as software programs tangibly contained in a machine-readable medium. In some examples, part or all of the software program may be loaded and/or installed onto the device 700 through the ROM 702. When the software program is loaded onto the RAM 703 and executed by the processor 701, one or more actions of the method 200A, the method 200B, or the training process 400 described above may be performed.

The functions described above herein can be performed, at least in part, by one or more hardware logic components. For example, and without limitation, exemplary types of hardware logic components that can be used comprise: Field Programmable Gate Arrays (FPGA), Application Specific Integrated Circuits (ASIC), Application Specific Standard Products (ASSP), System on a Chip (SOC), Complex Programmable Logic Devices (CPLD), and the like.

The program code for implementing the methods of the present disclosure can be written in any combination of one or more programming languages. This program code can be provided to a processor or controller of a general-purpose computer, special-purpose computer, or other programmable data processing devices such that the program code, when executed by the processor or controller, causes the functions/operations specified in the flowcharts and/or block diagrams to be implemented. The program code can be executed entirely on the machine, partly on the machine, as a stand-alone software package partly on the machine and partly on a remote machine, or entirely on a remote machine or server.

The present disclosure may be a method, an apparatus, and/or a program product. The program product may comprise a machine-readable storage medium carrying machine-readable program instructions for performing various aspects of the present disclosure. The machine-readable program instructions described herein may be downloaded from a machine-readable storage medium to various computing/processing devices, or downloaded to external computers or external storage devices from networks, such as the Internet, a local area network, a wide area network, and/or a wireless network. The networks may comprise copper transmission cables, optical fiber transmissions, wireless transmissions, routers, firewalls, switches, gateway computers, and/or edge servers. The network adapter card or network interface in each computing/processing device receives the machine-readable program instructions from the network and forwards the machine-readable program instructions for storage in a machine-readable storage medium of each computing/processing device.

The machine program instructions used to execute the operations of the present disclosure may be assembly instructions, instructions set architecture (ISA) instructions, machine instructions, machine-related instructions, microcode, firmware instructions, state-setting data, or source code or object code written with any combination of one or many programming languages, with the programming languages including object-oriented programming languages such as Smalltalk, C++, etc., as well as conventional procedural programming languages such as “C” language or similar programming languages. Machine-readable program instructions may be fully executed on the user's computer, partially executed on the user's computer, executed as an independent software package, partially executed on the user's computer and partially executed on a remote computer, or fully executed on a remote computer or server. Where a remote computer is involved, the remote computer may be connected to the user's computer through any type of network, including local area network (LAN) or wide area network (WAN), or it may be connected to an external computer (such as by using an Internet service provider for Internet connection). In some examples, the state information of machine-readable program instructions is used to personalize electronic circuits, such as a programmable logic circuit, a field-programmable gate array (FPGA), or a programmable logic array (PLA), wherein the electronic circuit is able to execute machine-readable program instructions, thereby achieving the various aspects of the present disclosure.

In the context of the present disclosure, a machine-readable medium can be a tangible medium that can contain or store programs for use by or in conjunction with an instruction execution system, apparatus, or device. A machine-readable medium can be a machine-readable signal medium or a machine-readable storage medium. The machine-readable medium can comprise, but is not limited to, electronic, magnetic, optical, electromagnetic, infrared, or semiconductor systems, apparatuses, or devices, or any suitable combination of the foregoing. More specific examples of the machine-readable storage medium would comprise electrical connections based on one or more wires, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing. Furthermore, although operations have been depicted in a specific order, it should be understood that such operations are not required to be performed in the specific order shown or in sequential order, nor are all illustrated operations required to be performed to achieve the desired results. In certain contexts, multitasking and parallel processing may be advantageous. Similarly, although several specific implementation details are included in the above discussion, these should not be construed as limiting the scope of the present disclosure. Certain features described in the context of separate examples can also be implemented in combination in a single implementation. Conversely, various features described in the context of a single implementation can also be implemented separately or in any suitable sub-combination in multiple implementations.

Although the subject matter has been described in language specific to structural features and/or methodological acts, it is to be understood that the subject matter defined in the appended Claims is not necessarily limited to the specific features or acts described above. Rather, the specific features and operations described above are merely exemplary forms of implementing the Claims.

1. A method for image instance segmentation, comprising:
determining, based on an input image, region of interest features of a target object in the input image and a target region image of the target object;
extracting shape features of the target object based on the target region image;
determining fused features of the target object based on the region of interest features and the shape features; and
based on the fused features, performing instance segmentation of the input image to generate a mask instance of the target object in the input image.

2. The method according to claim 1, wherein determining the region of interest features and the target region image comprises:
extracting image features of the input image based on the input image;
determining the region of interest features and a bounding box of the target object based on the image features; and
generating the target region image of the target object based on the bounding box.

3. The method according to claim 1, wherein determining based the fused features comprises:
determining the fused features by connecting the region of interest features and the shape features along a depth channel.

4. The method according to claim 1, wherein:
the input image contains at least partially invisible target objects and/or at least partially occluded target objects, and
based on the fused features, the input image undergoes instance segmentation to generate a mask instance of the target object in the input image, comprising performing amodal instance segmentation on the input image based on the fused features to generate the mask instance containing visible, invisible, and/or occluded parts of the target object in the input image.

5. The method according to claim 1, wherein:
the method is implemented by an image segmentation model,
the image segmentation model comprises a main model and an auxiliary model,
the main model comprises a fusion module for determining the fused features of the target object, and
the auxiliary model comprises a shape encoder for extracting the shape features of the target object.

6. A method for training an image segmentation model comprising a main model and an auxiliary model, the method comprising:
acquiring training samples comprising a plurality of sample images and a plurality of mask sample instances corresponding to sample objects in sample images of the plurality of sample images;
extracting, by the auxiliary model, shape features of the sample objects in the sample images;
performing instance segmentation of the sample images by the main model based on fused features to generate mask prediction instances of the sample objects in the sample images, the fused features being determined based on the region of interest features and shape features of the sample objects in the sample images;
generating by the auxiliary model, mask projection instances of the sample objects based on the shape features of the sample objects in the sample images and a camera pose; and
jointly training the main model and the auxiliary model based on the mask prediction instances and the mask projection instances, using the mask sample instances corresponding to the sample images as supervision signals.

7. The method according to claim 6, wherein performing instance segmentation of the sample images by the main model based on the fused features to generate the mask prediction instances of the sample objects in the sample images comprises:
determining the region of interest features of the sample object in a sample image of the plurality of images and a sample region image of the sample object based on the sample image;
extracting the shape features of the sample object by a shape encoder in the auxiliary model based on the sample region image;
determining the fused features of the sample object by a fusion module in the main model based on the region of interest features of the sample object and the shape features of the sample object; and
generating the mask prediction instance of the sample object in the sample image by a mask prediction network of the main model based on the fused features of the sample object.

8. The method according to claim 6, further comprising:
extracting the shape features of the sample object by a shape encoder in the auxiliary model based on a sample region image of the sample object and extracting the camera pose of the sample object by a view estimator in the auxiliary model.

9. The method according to claim 6, wherein generating the mask projection instances of the sample objects based on the shape features of the sample objects in the sample images and the camera pose comprises:
extracting a shape feature body of the sample object by a shape decoder in the auxiliary model based on the shape features of the sample object; and
generating the mask projection instance of the sample object by the auxiliary model based on the camera pose and the shape feature body.

10. The method according to claim 9, wherein generating the mask projection instance of the sample object by the auxiliary model based on the camera pose and the shape feature body comprises:
generating the a mask projection instance of the sample object in the sample image by differential rendering based on the camera pose and the shape feature body of the sample object in the sample image.

11. The method according to claim 9, wherein jointly training the main model and the auxiliary model based on the mask prediction instances and the mask projection instances, using the mask sample instances corresponding to the sample images as the supervision signals, comprises:
calculating a first loss value using a first loss function based on the mask sample instance and the mask prediction instance;
calculating a second loss value using a second loss function based on the mask sample instance and the mask projection instance; and
adjusting parameters of a the fusion module in the main model and a shape encoder and the shape decoder in the auxiliary model based on the first loss value and the second loss value.

12. The method according to claim 11, wherein the fusion module of the main model and the shape encoder in the auxiliary model are applied to an image instance segmentation inference process after the image segmentation model has been trained.

13. An apparatus for image instance segmentation, comprising:
at least one processor configured to:
generate region of interest features of a target object in an input image and a target region image of the target object based on the input image;
extract shape features of a target object based on the target region image;
determine fused features of the target object based on the region of interest features and the shape features; and
based on the fused features, perform instance segmentation of the input image to generate a mask instance of the target object in the input image.

14. An electronic device comprising:
at least one processor; and
a non-transitory memory coupled to the at least one processor and having instructions stored thereon, the instructions, when executed by the at least one processor causing the electronic device to perform the method according to claim 1.

15. The method according to claim 1, wherein:
a computer program product comprises a computer program, and
the computer program is executed by at least one processor to implement the method.
